(19) United States
(12) Patent Application Publication
(10) Pub. No.: US 2007/0203892 A1
(43) Pub. Date: Aug. 30, 2007

(54) Apparatus and method for using vertical hierarchies in conjuction with hybrid slowly changing dimension tables

(75) Inventors: Scott Adams, Guildford (GB); David Mark Brown, Windsor (GB)

Correspondence Address: COOLEY GODWARD KRONISH LLP;ATTN: Patent Group, Suite 500, 1200 - 19th Street, NW, Washington, DC, 20036-2402, US

(73) Assignee: Business Objects, S.A., Levallois-Perret (FR)

(21) Appl. No.: 11/364,560

(22) Filed: Feb. 27, 2006

(51) Int. Cl. G06F 17/30

(52) U.S. Cl. 707/3

(57) ABSTRACT

A computer readable medium stores executable instructions to define a hybrid slowly changing dimension table; establish vertical hierarchy tables from the hybrid slowly changing dimension table; query a first vertical hierarchy table to produce first results characterizing current hierarchical relationships; and query a second vertical hierarchy table to produce second results characterizing historical hierarchical relationships.

### BRIEF DESCRIPTION OF THE INVENTION

This invention relates generally to data processing. More particularly, this invention relates to the use of vertical hierarchies in conjunction with hybrid slowly changing dimension tables to provide historical information on hierarchical data.

### BACKGROUND OF THE INVENTION

Over time structures within an organization change. For example, products change categories, employees change names, and customers change addresses. In most cases these changes are applied directly to an operational database, overwriting historical data. However, there is often a need to be able to analyze and report data based on new and old values. In particular, there is a need to track these changes in such a way that reports can be easily generated to show new and historical data, and in particular, to show this for hierarchical data.

Various tools are currently used to analyze organizational data. One such tool is a data warehouse. A data warehouse is a logical collection of information gathered from many different operational databases. The data warehouse is used to analyze aggregated data. The data analyses may be in the form of business intelligence analyses that assess business activities. A data warehouse stores an enterprise's past transactional and operational information in a manner to optimize efficient data analysis and reporting. A data warehouse is not configured for current “live” data.

A data mart is a specialized version of a data warehouse. A data mart contains a snapshot of operational data that helps individuals develop strategies based upon analyses of past trends and experiences. A data mart is based upon a specific, predefined need for a certain grouping and configuration of select data, for example marketing data.

Ralph Kimball is a well known computer scientist who has characterized the changes that transpire in databases, data warehouses and data marts. He has developed categories that characterize different types of changes. These categories or definitions are well known in the art and include Type I, Type II and Type III data changes. These categories characterize the different ways in which changes in source data can be recorded in a data warehouse or a data mart.

Type I changes do not preserve historical information. Instead, information is simply overwritten to reflect a current value. The use of Type I data changes is most appropriate when processing data source corrections. With a Type II change, a new row with a new surrogate primary key is inserted into the dimension table to capture changes. Both the prior and new rows contain as attributes the natural key (or durable identifier), the most-recent-row flag and the row effective and expiration dates. With a Type III change, another attribute is added to the existing dimension row to support analysis based on either the new or prior attribute value. The term “slowly changing dimension” is frequently used in connection with Type II and Type III changes.

It would be desirable to provide new techniques for analyzing Type II and/or Type III slowly changing dimensions. In particular, it would be desirable to provide new data structures and processing techniques to provide multiple historical perspectives of hierarchical data, notwithstanding changes in hierarchical structures and values.

### SUMMARY OF THE INVENTION

The invention includes a computer readable medium with executable instructions to define a hybrid slowly changing dimension table; establish vertical hierarchy tables from the hybrid slowly changing dimension table; query a first vertical hierarchy table to produce first results characterizing current hierarchical relationships; and query a second vertical hierarchy table to produce second results characterizing historical hierarchical relationships.

The invention also includes a method of processing data by defining a hybrid slowly changing dimension table; establishing vertical hierarchy tables from the hybrid slowly changing dimension table; querying a first vertical hierarchy table to produce first results characterizing current hierarchical relationships; and querying a second vertical hierarchy table to produce second results characterizing historical hierarchical relationships.

The invention provides a conformed dimensional data model to define hybrid slowly changing dimension tables and to associate them with vertical hierarchy tables such that multiple historical perspectives of hierarchical data are maintained despite changes in the structure and identifying values of hierarchical data.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

FIG. 3 illustrates an employee hierarchy that may be processed in accordance with an embodiment of the invention.

FIG. 4 illustrates a primary dimension table capturing the information of FIG. 3.

FIG. 5 illustrates a vertical hierarchy table comprising information from the primary dimension table of FIG. 4.

FIG. 6 is a fact table with information from the primary dimension table of FIG. 3.

FIG. 7 illustrates an altered employee hierarchy that may be processed in accordance with an embodiment of the invention.

FIG. 8 illustrates a primary dimension table capturing the information of FIG. 7.

FIG. 9 illustrates a vertical hierarchy table comprising information from the primary dimension table of FIG. 8.

FIG. 10 illustrates a fact table with information from the primary dimension table of FIG. 8.

Like reference numerals refer to corresponding parts throughout the several views of the drawings.

### DETAILED DESCRIPTION OF THE INVENTION

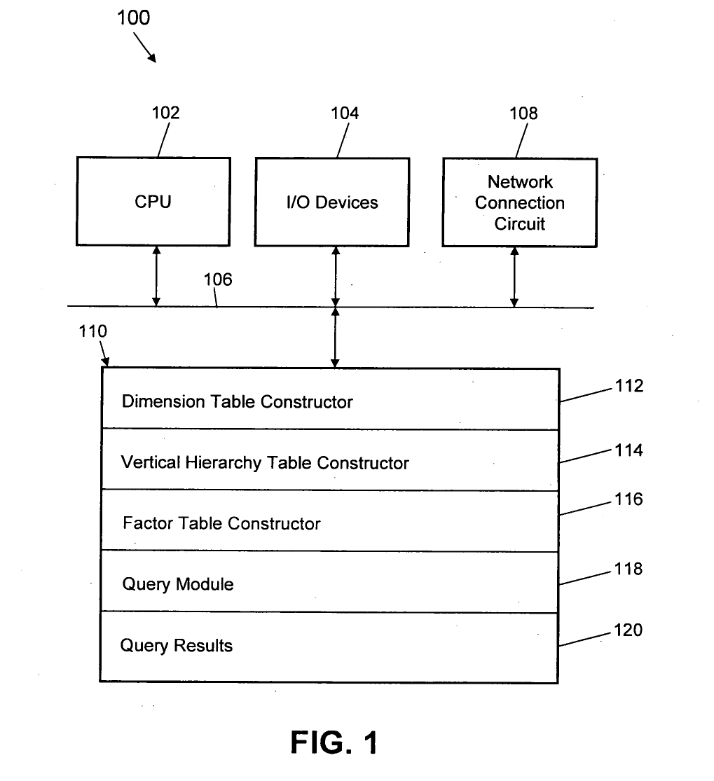

FIG. 1 illustrates a computer 100 configured in accordance with an embodiment of the invention. The computer 100 includes a central processing unit 102 connected to a set of input/output devices (e.g., a keyboard, mouse, display, printer, etc.) 104 via a bus 106. A network connection circuit 108 is also connected to the bus 106. The network connection circuit 108 provides an interface to a network (not shown) so that the computer 100 may operate in a networked environment.

A memory 110 is also connected to the bus 106. The memory 110 stores executable instructions to implement operations associated with the invention. For example, the memory 110 stores a dimension table constructor 112, which includes executable instructions to construct a primary dimension table corresponding to hierarchical information, examples of which are provided below. The memory 110 also stores a vertical hierarchy constructor 114, which includes executable instructions to construct vertical hierarchy tables corresponding to information in a primary dimension table. Examples of vertical hierarchy tables are provided below.

The memory 110 also stores a fact table constructor 116. The fact table constructor 116 includes executable instructions to produce a subset of information from the primary dimension table. The memory 110 also stores a query module 118. The query module 118 may be implemented in any number of ways. For example, the query module 118 may configured to accept a query produced by a user, it may automatically create queries, and/or it may prompt a user to form a query in an interactive process. Regardless of the implementation, the query module 118 operates to query a first vertical hierarchy table to produce a first set of query results 120 and then query a second vertical hierarchy table to produce a second set of query results 120. One set of results represents current hierarchical relationships, while another set of results represents historical hierarchical relationships.

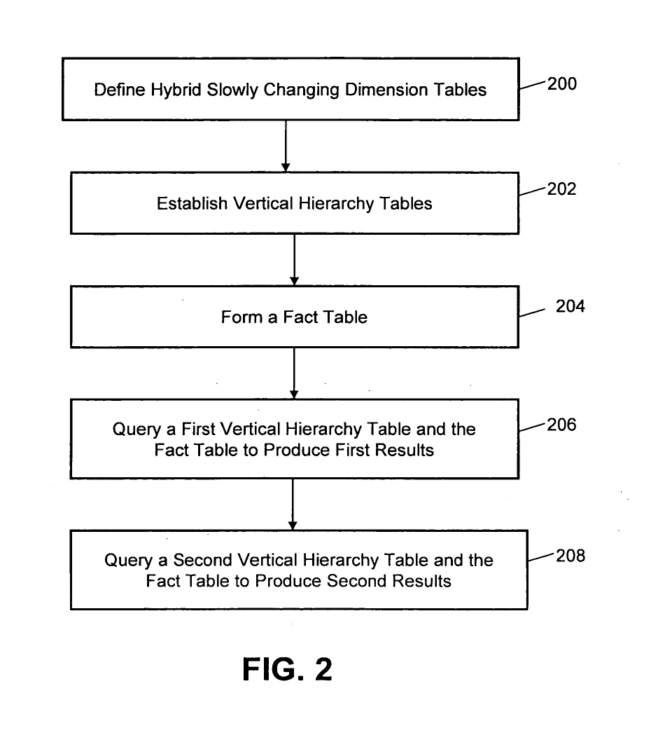

FIG. 2 illustrates processing operations associated with an embodiment of the invention. Initially, a hybrid slowly changing dimension table is defined. The dimension table constructor 112 may be used to implement this operation. Vertical hierarchy tables are then established 202. The vertical hierarchy tables capture the hierarchical information of the dimension table. The vertical hierarchy table constructor 114 may be used to implement this operation. A fact table is then formed 204. The fact table constructor 116 may be used to produce a subset of information from a dimension table in accordance with specified criteria.

The next operation of FIG. 2 is to query a first vertical hierarchy table and a fact table to produce a first set of results 206. Next, the fact table in combination with a second vertical hierarchy table is queried 208. These operations may be implemented with the query module 118. By way of example, the first set of results captures current hierarchical relationships, since a first vertical hierarchy table with such information is queried, while the second set of results captures historical hierarchical relationships, since a second vertical hierarchy table with such information is queried. Thus, the invention allows a single query, specifying different vertical hierarchical tables, to capture different types of information, namely, current and historical hierarchical information.

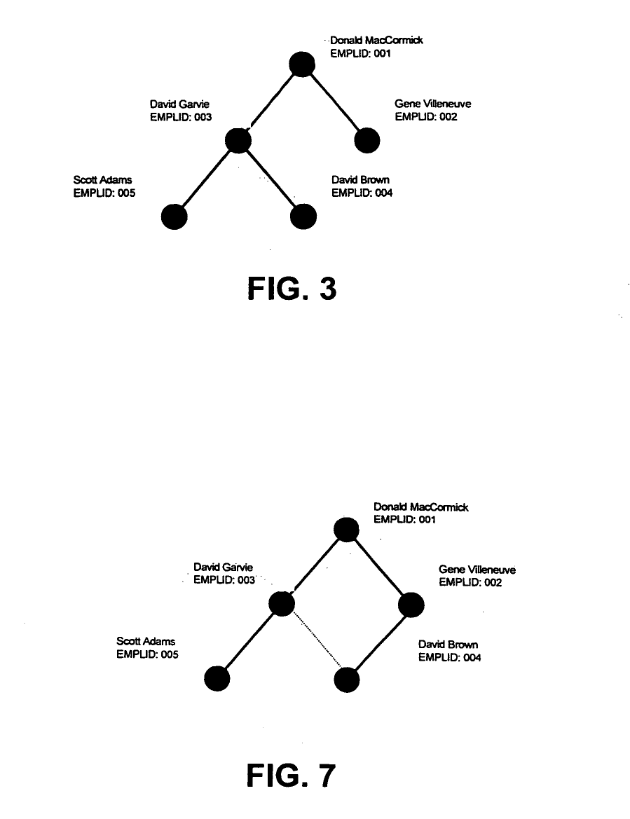

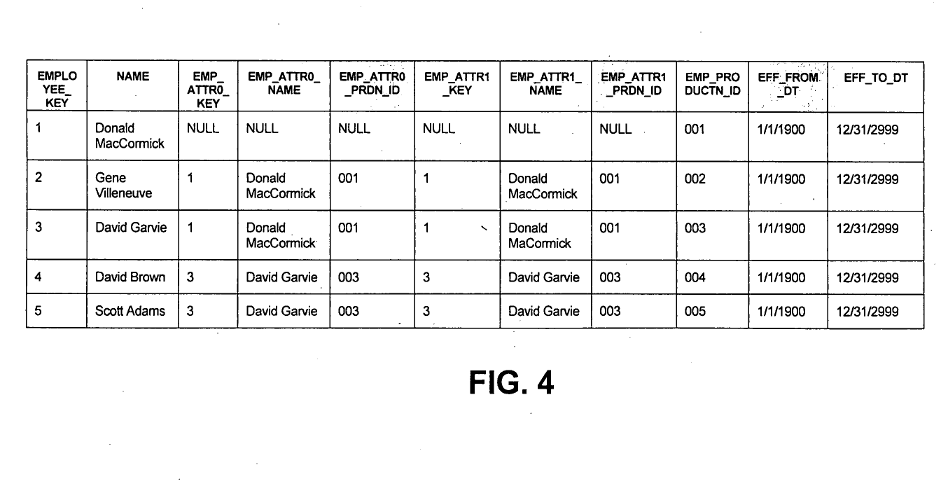

The operations and advantages of the invention are more fully appreciated in connection with a specific example. FIG. 3 illustrates an exemplary employment hierarchy. In this example, Donald MacCormick with an employee ID of 001 (EMPLID:001) has two individuals that report to him: David Garvie (EMPLID: 003) and Gene Villeneuve (EMPLID: 002). In turn, two employees report to David Garvie, namely: Scott Adams (EMPLID: 005) and David Brown (EMPLID: 004). This employment hierarchy may be characterized in a table. In particular, the table of FIG. 4 may be used to represent the same information as in FIG. 3.

The first column of FIG. 4 is EMPLOYEE_KEY, which corresponds to the surrogate key, i.e., the unique identifier of a specific employee's details at a specific instant. The second column of FIG. 4 is the employee name, which is also supplied in FIG. 3. The “reports to” attribute of the hierarchy may be characterized by the “attribute 0” or ATTR0 attribute fields. In this example, columns are provided for an EMP_ATTR0_KEY, an EMP_ATTR0_NAME, and an EMP_ATTR0_PRDN_ID. Observe that the EMP_ATTR0_KEY and EMP_ATTR0_PRDN_ID values correspond to the EMPLID values of FIG. 3. Similarly, the EMP_ATTR0_NAME values correspond to the employee name information of FIG. 3.

FIG. 4 also includes “attribute 1” or ATTR1 attribute fields. This field holds the current reporting relationship. This information allows one to re-state historical data against a current structure. At this point in time, the values for the EMP_ATTR1_KEY correspond to the EMP_ATTR0_KEY values, the EMP_ATTR1_NAME values correspond to the EMP_ATTR0_NAME values, and the EMP_ATTR1_PRDN_ID values correspond to the EMP_ATTR0_PRDN_ID. The table also includes a EMP_PRODUCTN_ID column with sequential employee numbers and an effective from date (EFF_FROM_DT) column and an effective to date (EFF_TO_DT) column.

Using the dimension table of FIG. 4, two hierarchies can be built:
1. Historical Manager (EMP_ATTR0_PRDN_ID->EMP_PRODUCTN_ID)
2. Current Manager (EMP_ATTR1_PRDN_ID->EMP_PRODUCTN_ID)

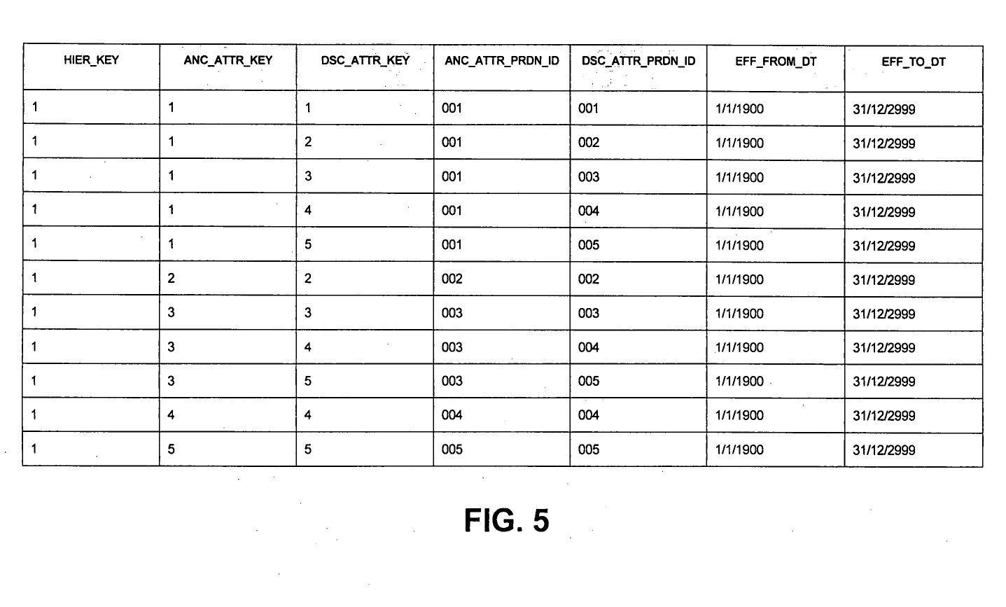

This table, when converted to a vertical hierarchy table DIM_EMP_HIER contains rows as shown in FIG. 5. The vertical hierarchy table of FIG. 5 contains every relationship between every tree node. That is, the vertical hierarchy table of FIG. 5 contains every length relationship between every ancestor and descendent of the hierarchy of FIG. 3. All rows generated in the vertical hierarchy table are derived from the primary dimension table of FIG. 4. In other words, the primary dimension table of FIG. 4 operates as a data source for the vertical hierarchy table of FIG. 5.

The table of FIG. 5 may be constructed in a multi-pass process. Referring to the hierarchy of FIG. 3, Donald MacCormick is the ancestor and all the nodes beneath are his descendants. The first row of the table of FIG. 5 contains one row for Donald. The following 4 rows specify each of his descendants. The ANC_ATTR_KEY contains the EMPLOYEE_KEY for Donald and the DSC_ATTR_KEY contains the EMPLOYEE_KEY for his descendant. The same logic applies to the ANC_ATTR_PRODN_ID and DSC_ATTR_PRODN_ID.

On a second pass, the vertical hierarchy table is populated with information on David Garvie. This results in three more rows: one row for David and two rows for David's two descendants. On the third pass, the vertical hierarchy table is populated with information on Gene Villeneuve. Since Gene has no descendants, only a single row is produced to characterize Gene; in particular, the ninth row of the table is used to characterize Gene. On the fourth pass, the vertical hierarchy table is populated with information on the bottom or leaf nodes, which in this case corresponds to Scott Adams and David Brown. Information on David Brown is populated in the eleventh row of the table, while information on Scott Adams is populated in the final row of the table.

Although not shown in a separate figure, the rows of FIG. 5 would be repeated for the second hierarchy since there has not been a change in employee hierarchical structure. In other words, the current and historical hierarchies are the same at this point in time.

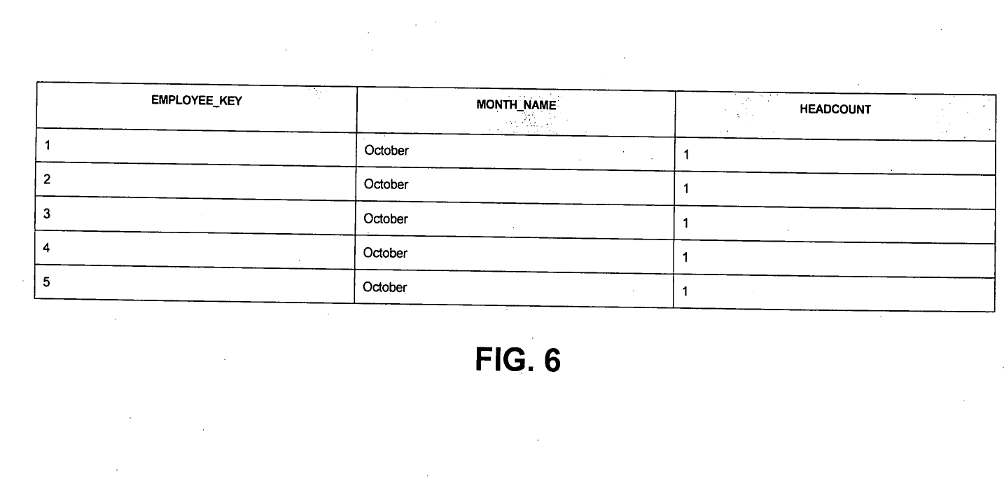

In order to fully explore this example, consider the fact table of FIG. 6, which is referred to as FCT_HEADCOUNT. This fact table will record a 1 or 0 for each employee for each month that they are to be counted as an active headcount, as based upon their current status. Assume that the current month is October 2005. In this case, the table contains the data of FIG. 6.

One can now use the vertical hierarchy (i.e., the table of FIG. 5) to report on the fact table (i.e., the table of FIG. 6). For example, one can perform the following SQL:

SELECT ANC_ATTR_PRDN_ID, MONTH_NAME,
SUM(HEADCOUNT)
FROM DIM_EMP_HIER, FCT_HEADCOUNT
WHERE DIM_EMP_HIER.DSC_ATTR_KEY =
FCT_HEADCOUNT.EMPLOYEE_KEY
AND DIM_EMP_HIER.ANC_ATTR_PRDN_ID IN
(‘002’, ‘003’)
AND DIM_EMP_HIER.HIER_KEY = 1
GROUP BY ANC_ATTR_PRDN_ID, MONTH_NAME

This query results in the following information:

| PRDN ID | MONTH NAME | SUM(HEADCOUNT) |
|---|---|---|
| 002 | October | 1 |
| 003 | October | 3 |

This means that reporting the headcount for ‘Gene Villeneuve’ results in one record stating that the headcount was 1 for October. Reporting for ‘David Garvie’ results in one record stating that the headcount was 3 (David Garvie and two reports) for October.

Now consider a change in the employee hierarchy, as shown in FIG. 7. As of 11/1/2005 David Brown reports to Gene Villeneuve. Now David Brown reported to David Garvie from 1/1/1900 to 10/31/2005 and to Gene Villeneuve from 11/1/2005 to 12/31/2999.

The dimension table may be used to capture this change in information. The dimension table uses the hybrid approach (Type II or Type III) to manage slowly changing data. This approach retains the current and previous values in separate columns in the dimension table. In addition, a new row is inserted into the dimension table with each change. During the incremental loading of the dimension table, if a record is found in the dimension table that has different attribute/column values from those in the incoming record for the same operational system key, then a new surrogate key is generated and a new record is inserted into the dimension table. Additionally, the current values of the changed attributes are updated in all rows corresponding to the operation system key.

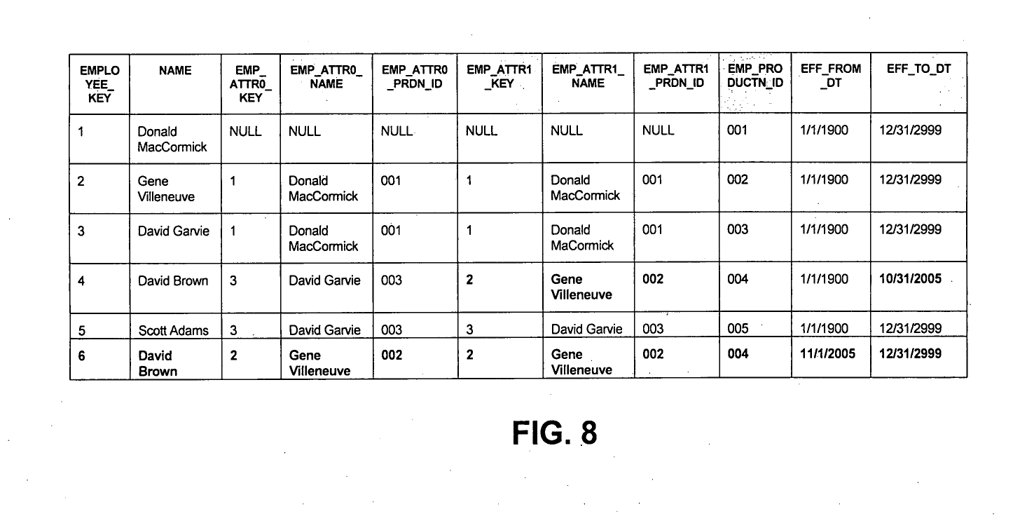

FIG. 8 illustrates the DIM_EMP dimension table that captures this change in hierarchical structure. Remember that we are using EMP_ATTR0_* to track the historically accurate ‘reports to’ relationship, and we are using EMP_ATTR1_* to effectively re-state history according to the current ‘reports to’ relationship.

FIG. 8 corresponds to FIG. 4, except that the column values EMP_ATTR1_KEY, EMP_ATTR1_NAME and EFF_TO_DT of row 4 are changed to reflect the new reporting structure. In addition, row 6 has been added to reflect the new reporting structure. These changes are shown in bold in FIG. 8.

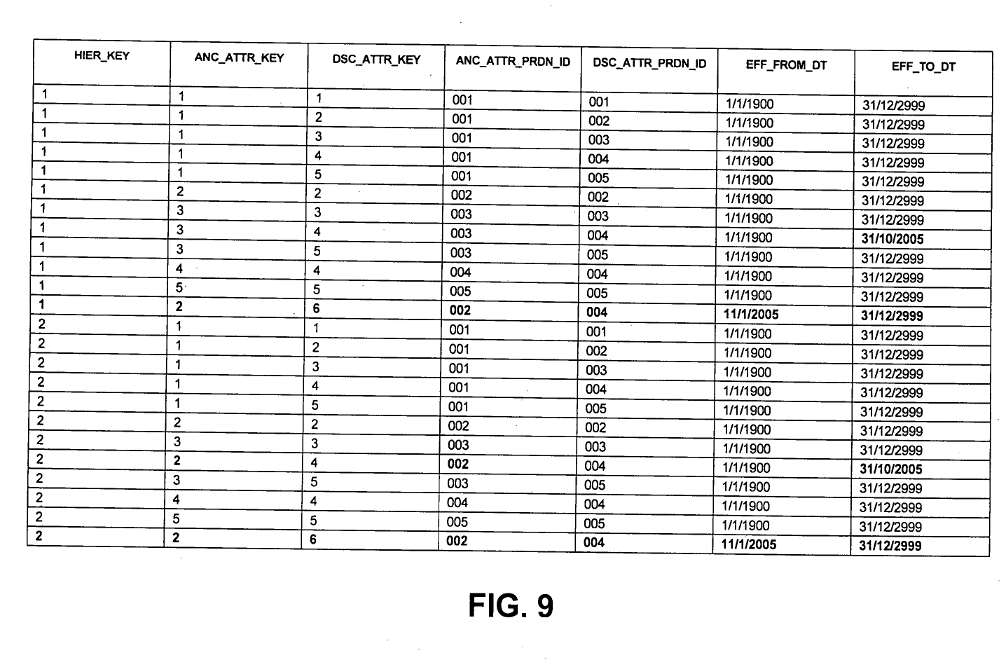

When the vertical hierarchy table DIM_EMP_HIER is rebuilt, the table of FIG. 9 results. The table of FIG. 9 may be considered two tables: one table associated with HIER_KEY 1, including the first twelve rows of the table, and a second table associated with HIER_KEY 2, including the remaining rows in the table. Notice that in hierarchy 1, David Brown has changed from reporting to David Garvie (003) to Gene Villeneuve (002). However in hierarchy 2 it appears that David Brown has always reported to Gene Villeneuve. The relevant information reflecting these changes is shown in bold.

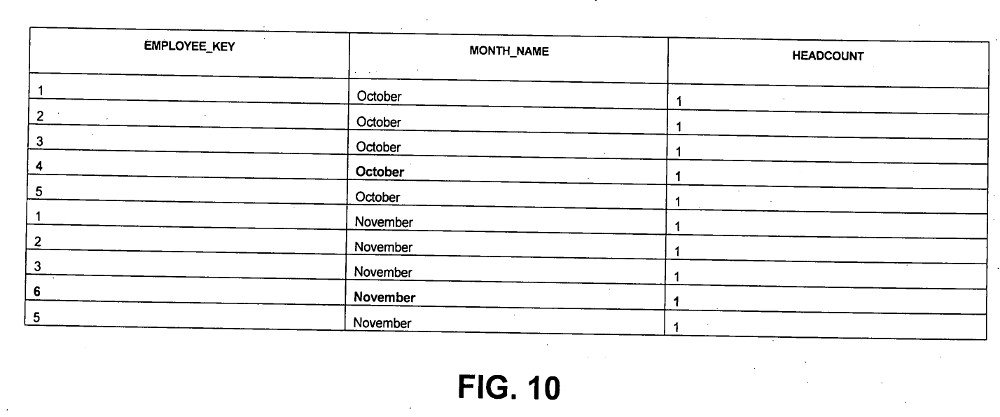

Now that we have rolled over a new month, we have new headcount data to record. Note that because David Brown now has a new surrogate key value, 6, for November, this is the new key that will be used in a fact table FCT_HEADCOUNT, which is shown in FIG. 10. In FIG. 10, David Brown's original EMPLOYEE_KEY is 4, which has an entry for October in the MONTH_NAME column. David Brown's new EMPLOYEE_KEY is 6, which corresponds to the month of November in the MONTH_NAME column.

Now, the same query is executed, this time taking into account the change in structure and the new data in the fact table of FIG. 10:

SELECT ANC_ATTR_PRDN_ID, MONTH_NAME,
SUM(HEADCOUNT)
FROM DIM_EMP_HIER, FCT HEADCOUNT
WHERE DIM_EMP_HIER.DSC_ATTR_KEY =
FCT_HEADCOUNT.EMPLOYEE_KEY
AND DIM_EMP_HIER.ANC_ATTR_PRDN_ID IN
(‘002’, ‘003’)
AND DIM_EMP_HIER.HIER_KEY = 1
GROUP BY ANC_ATTR_PRDN_ID, MONTH_NAME

The foregoing query results in the following information:

| PRDN ID | MONTH NAME | SUM(HEADCOUNT) |
|---|---|---|
| 002 | October | 1 |
| 003 | October | 3 |
| 002 | November | 2 |
| 003 | November | 2 |

We can see that the headcount for 002 has increased by 1 as 002 now returns keys 2 and 6 (and we now have data for key 6 in November), where as 003 headcount has dropped by 1 as this is returning keys 3 and 4 (and we no longer have data for key 4 in November).

However, if we instead choose to use hierarchy 2 for the same query, we will see a different result. This is because we have chosen to implement hierarchy 2 as a kind of “re-statement hierarchy”. The query against the second hierarchy is:

SELECT ANC_ATTR_PRDN_ID, MONTH_NAME,
SUM(HEADCOUNT)
FROM DIM_EMP_HIER, FCT_HEADCOUNT
WHERE DIM_EMP_HIER.DSC_ATTR_KEY =
FCT_HEADCOUNT.EMPLOYEE_KEY
AND DIM_EMP_HIER.ANC_ATTR_PRDN_ID IN
(‘002’, ‘003’)
AND DIM_EMP_HIER.HIER_KEY = 2
GROUP BY ANC_ATTR_PRDN_ID, MONTH_NAME

This query produces:

| PRDN ID | MONTH NAME | SUM(HEADCOUNT) |
|---|---|---|
| 002 | October | 2 |
| 003 | October | 2 |
| 002 | November | 2 |
| 003 | November | 2 |

Thus, the invention provides a simple structure where one can report using the historically accurate relationships or re-state an aggregation using the current relationships. Using a prompt handling mechanism, this can be made totally visible to the user such that the user can opt to use either hierarchy to run a single report.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium storing executable instructions, including executable instructions to:
define a hybrid slowly changing dimension table;
establish vertical hierarchy tables from the hybrid slowly changing dimension table;
query a first vertical hierarchy table to produce first results characterizing current hierarchical relationships; and
query a second vertical hierarchy table to produce second results characterizing historical hierarchical relationships.

2. The computer readable medium of claim 1 further comprising executable instructions to:
form a fact table with information from the hybrid slowly changing dimension table;
wherein the query of the first vertical hierarchy table includes a query of the fact table; and
wherein the query of the second vertical hierarchy table includes a query of the fact table.

3. The computer readable medium of claim 1 wherein the executable instructions to define a hybrid slowly changing dimension table include executable instructions to define a Type II slowly changing dimension table.

4. The computer readable medium of claim 1 wherein the executable instructions to define a hybrid slowly changing dimension table include executable instructions to define a Type III slowly changing dimension table.

5. A method of processing data, comprising:
defining a hybrid slowly changing dimension table;
establishing vertical hierarchy tables from the hybrid slowly changing dimension table;
querying a first vertical hierarchy table to produce first results characterizing current hierarchical relationships; and
querying a second vertical hierarchy table to produce second results characterizing historical hierarchical relationships.

6. The method of claim 5 further comprising:
forming a fact table with information from the hybrid slowly changing dimension table;
wherein querying the first vertical hierarchy table includes querying the fact table; and
wherein querying the second vertical hierarchy table includes querying the fact table.

7. The method of claim 5 wherein defining a hybrid slowly changing dimension table includes defining a Type II slowly changing dimension table.

8. The method of claim 5 wherein defining a hybrid slowly changing dimension table includes defining a Type III slowly changing dimension table.
